(19) United States
(12) Patent Application Publication
(10) Pub. No.: US 2006/0125833 A1
(43) Pub. Date: Jun. 15, 2006

(54) Image display device and method thereof

(76) Inventor: Wen-Chi Hung, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/289,590

(22) Filed: Nov. 30, 2005

(30) Foreign Application Priority Data
Dec. 10, 2004 (TW) 93138459

(51) Int. Cl. G06F 13/14

(52) U.S. Cl. 345/520; 345/501

(57) ABSTRACT

An image display device and a method thereof are proposed to solve the problem of bad image processing performance of existent image display devices. The image display device comprises an image processing controller, a transmission interface for input of an image signal, a plurality of graphics processing unit for graphics acceleration, an image memory for storing the image signal, and a video signal generating module for providing a video signal to a display device. The graphics processing units respectively process the image signal in the image memory so that the image processing controller can control the video signal generating module to perform image modulation to the image signal according to the operation results of the graphics processing units. The video signal generating module then generates a video signal for output. Through these graphics processing units, the whole performance can be enhanced.

### BACKGROUND OF THE INVENTION

1. Field of the invention

The present invention relates to an image display device and method and, more particularly, to an image display device and method used in a computer system to provide output image signals to a display.

2. Description of Related Art

For the computer display technology, since the IBM set the well-known VGA standard into action, the graphics display technology giving first priority to image display modules has been continually improved, from the ISA interface specification (16 bit@8.33 MHz) in the 80s through peripheral component interconnect (PCI) interface specification (32 bit@33 MHz) to recent accelerated graphics port (AGP) interface specification (32 bit@66 MHz). The primary object is nothing more than to enhance the bandwidth of the transmission interface so as to improve the whole display efficiency.

As shown in FIG. 1, an image display device 7 can be a display card or a display chip module disposed on a computer motherboard. A transmission interface 71 of the image display device 7 is used to receive an image signal to be displayed output by a chipset 8. The image signal is stored into an image memory 73. A graphics processing unit 72 performs graphics acceleration to the image signal stored in the image memory 73 to reduce the load of a central processing unit (CPU). A cathode ray tube controller (CRTC) 70 properly processes each pixel color of the image signal and then outputs to a video signal generating module 74. The video signal generating module 74 generates a video signal and outputs to a display (not shown). The CRTC 70 also outputs a video synchronization signal to the display to match the output of the video signal.

For the image display device 7 shown in FIG. 1, the operation performance provided by the graphics processing unit 72 can afford the transmission efficiency provided by the transmission interface 71 before the formal release of the peripheral component interconnect-express (PCI-E). But the situation totally transforms when the PCI-E interface is introduced into the market, causing that the operation efficiency of the graphics processing unit 72 can no longer keep pace with the transmission efficiency of the PCI-E interface. Moreover, along with the requirement of faster 3D graphics processing in the gaming market demanding real-time rendering and fidelity, the tremendous amount of data processing already surpasses the processing capability of the common image display device 7. In order to solve this problem, dual image display devices working together through software have been proposed to process parallel. The performance enhanced, however, is limited, but the increased hardware cost and the required hardware equipment having two slots cause much inconvenience of user.

### SUMMARY OF THE INVENTION

An object of the present invention is to provide an image display device and a method thereof to solve the problem that the image processing capability cannot keep pace with the transmission speed of the transmission interface occurred in the prior art image display device having only a single graphics processing unit. The present invention provides a design of multiple graphics processing units to enhance the operation performance.

To achieve the above object, the present invention provides an image display device comprising a transmission interface for receiving an image signal, an image memory for storing the image signal, a plurality of graphics processing units for respectively performing graphics acceleration to the image signal stored in the image memory, a video signal generating module for modulating the image signal into a video signal for output, and an image processing controller for controlling the video signal generating module to modulate the image signal according to the operation results of the graphics processing units.

The above transmission interface can be a PCI interface, a PCI-E interface, or an AGP interface.

The above graphics processing units can be 3D or 2D graphics processing units.

To achieve the above object, the present invention also provides an image display method comprising the steps of: providing a transmission interface to receive an image signal; storing the image signal into an image memory; using a plurality of graphics processing units to respectively perform graphics acceleration to the image signal stored in the image memory; providing an image processing controller to transmit operation results of the graphics processing units to a video signal generating module; and using the video signal generating module to modulate the image signal into a video signal for output.

In the present invention, several graphics processing units are integrated into an image display device to jointly process an image signal in an image memory to accomplish graphics acceleration. The transmission interface adopted is an PCI-E interface capable of greatly enhancing the data transmission speed. Therefore, the whole operation performance of the image display device can be greatly enhanced.

### BRIEF DESCRIPTION OF THE DRAWINGS

The various objects and advantages of the present invention will be more readily understood from the following detailed description when read in conjunction with the appended drawing, in which:

FIG. 1 is a block diagram of a prior art image display device; and

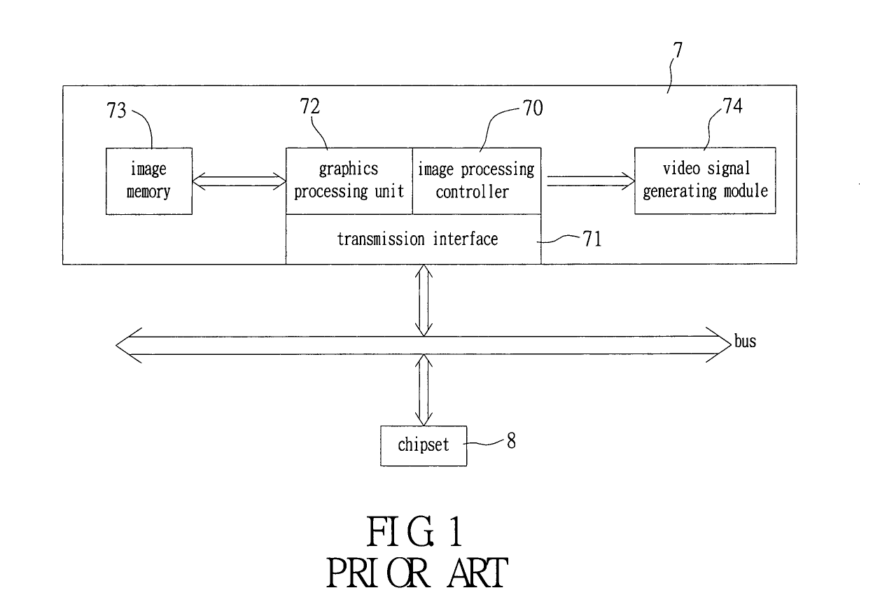

FIG. 2 is a block diagram of an image display device according to a preferred embodiment of the present invention.

### DETAILED DESCRIPTION OF THE PREFERRED EMBODIMENTS

In order to solve the problem that the image processing capability cannot keep pace with the transmission speed of the PCI-E interface occurred in the prior art image display device, the present invention provides an internal architecture of image display device different from the past solutions to enhance the operation performance of image processing.

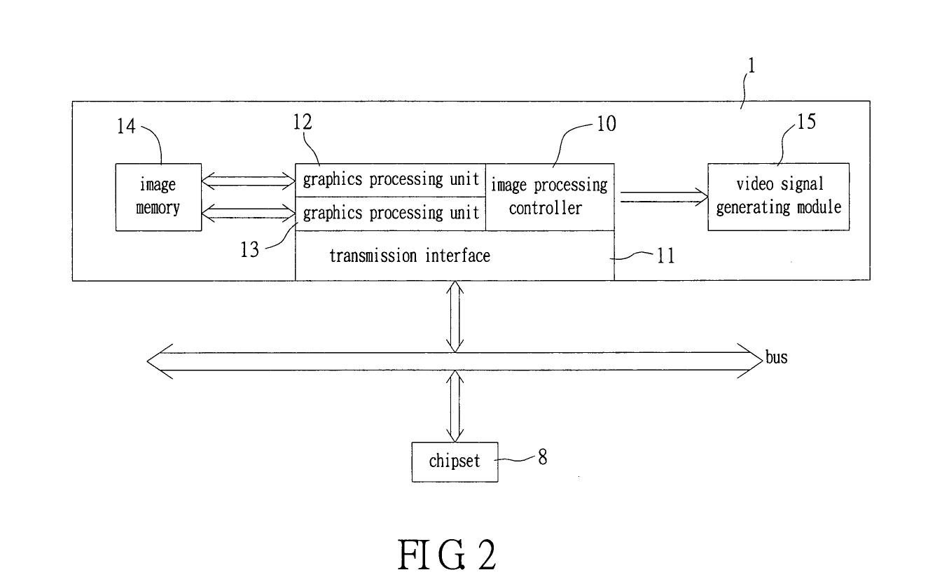

As shown in FIG. 2, an image display device 1 comprises an image processing controller 10, a transmission interface 11, a plurality of graphics processing units 12 and 13, an image memory 14, and a video signal generating module 15. The image display device 1 differs from the prior art primarily in that a plurality of graphics processing units (12 and 13) is provided. The number of the graphics processing units can be two or more. Through simultaneous or partial operation of the graphics processing units (12 and 13), the operation performance of the image display device 1 can be enhanced.

The image processing controller 10 is the control core for image operations. In addition to outputting a video synchronization signal to a display (not shown), the image processing controller 10 also controls the signal processing between the graphics processing units 12 and 13 and the video signal generating module 15. The graphics processing units 12 and 13 provide 3D/2D graphics acceleration required during the image processing process such as block fill, block move, and so on. The graphics processing units 12 and 13 can be 3D or 2D graphics processing units. The video signal generating module 15 can modulate each pixel color processed by the image processing controller 10 to provide a video signal to the display. The video signal generating module 15 comprises a look up table (LUT), a multiplexer (MUX), a gamma controller, a digital-to-analog converter (DAC), a dither, and so on. The transmission interface 11 provides data transmission with a chipset 2 of a computer system. The transmission interface 11 is preferred to be a PCI-E interface, but can also be a PCI interface or an AGP interface.

The image display method of the image display device 1 comprises the following steps. First, the transmission interface 11 receives an image signal to be displayed output by the chipset 2, and stores the image signal into the image memory 14. The graphics processing units 12 and 13 then respectively perform graphics acceleration to the image signal stored in the image memory 14 to reduce the load of the CPU. Next, the image processing controller 10 properly processes each pixel color of the image signal and outputs to the video signal generating module 15. The video signal generating module 15 generates a video signal to the display. The image processing controller 10 also outputs a video synchronization signal to the display to match the output of the video signal.

To sum up, the image display device 1 can speed up the processing of an image signal stored in the image memory 14 through the graphics processing units 12 and 13 working together to solve the problem that the processing speed of the image display device 1 cannot keep pace with the bandwidth of the transmission interface 11. Besides, in order to deal with tremendous amount of input data, the transmission interface 11 is preferred to be a PCI-E interface. The whole operation performance of the image display device 1 can thus be greatly enhanced, and is much superior to the conventional image display device having only a single graphics processing unit.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An image display device comprising:
a transmission interface for receiving an image signal;
an image memory for storing said image signal;
a plurality of graphics processing units for graphics acceleration of said image signal stored in said image memory;
a video signal generating module for modulating said image signal into a video signal for output; and
an image processing controller for controlling said video signal generating module to perform image modulation to said image signal according to operation results of said graphics processing units.

2. The image display device as claimed in claim 1, wherein said transmission interface is a PCI interface, a PCI-E interface, or an AGP interface.

3. The image display device as claimed in claim 1, wherein said graphics processing units are 3D or 2D graphics processing units.

4. An image display method comprising the steps of:
providing a transmission interface to receive an image signal;
storing said image signal into an image memory;
using a plurality of graphics processing units to respectively perform graphics acceleration to said image signal stored in said image memory;
providing an image processing controller to transmit operation results of said graphics processing units to a video signal generating module; and
using said video signal generating module to modulate said image signal into a video signal for output.

5. The image display method as claimed in claim 4, wherein said transmission interface is a PCI interface, a PCI-E interface, or an AGP interface.

6. The image display method as claimed in claim 4, wherein said graphics processing units are 3D or 2D graphics processing units.
